(19) United States
(12) Patent Application Publication
(10) Pub. No.: US 2014/0233858 A1
(43) Pub. Date: Aug. 21, 2014

(54) IMAGE CREATING DEVICE, IMAGE CREATING METHOD AND RECORDING MEDIUM STORING PROGRAM

(71) Applicant: CASIO COMPUTER CO., LTD., Tokyo (JP)

(72) Inventors: Ryohei YAMAMOTO, Tokyo (JP); Shigeru KAFUKU, Tokyo (JP); Keisuke SHIMADA, Tokyo (JP); Hirokiyo KASAHARA, Tokyo (JP); Masaaki SASAKI, Tokyo (JP)

(73) Assignee: CASIO COMPUTER CO., LTD., Tokyo (JP)

(21) Appl. No.: 14/180,899

(22) Filed: Feb. 14, 2014

(30) Foreign Application Priority Data
Feb. 18, 2013 (JP) 2013-029064

(51) Int. Cl. G06K 9/00

(52) U.S. Cl. CPC G06K 9/00268
USPC 382/195

(57) ABSTRACT

Disclosed is an image creating device including an extraction section which extracts a plurality of feature parts of a face in an image and a creating section which creates a portrait image of the face on a basis of the feature parts extracted by the extraction section. The device further includes a specifying section which specifies, among the plurality of feature parts extracted by the extraction section, a feature part to be used as a feature in the portrait image by setting any one of a usage of the portrait image created by the creating section, a characteristic of the face and a relation between a person corresponding to the face and a user as a reference and a creation control section which control creation of the portrait image by the creating section on a basis of the feature part specified by the specifying section.

### BACKGROUND OF THE INVENTION

1. Field of the Invention

The present invention relates to an image creating device, an image creating method and a recording medium in which a program is stored.

2. Description of the Related Art

Conventionally, there has been known a portrait creation device that creates a portrait by using feature points of face components such as eyes, nose, mouth, ears and facial contour (see JP 2004-145625).

However, in the case of JP 2004-145625, there is a possibility that a portrait in which a face component which a subject, who is the model of the portrait, is not fond of among the face components such as eyes, nose and mouth is exaggerated is to be created. Further, a person who looks as the portrait may not be able to obtain great satisfactory in a case where a portrait in which the features of a subject are not expressed to their full extent is created.

### SUMMARY OF THE INVENTION

In view of the above problems, an object of the present invention is to provide an image creating device and an image creating method which can appropriately perform face portrait image creation from a view point of user's satisfaction and a recording medium in which a program of the method is stored.

According to an embodiment of the present invention, there is provided an image creating device includes an extraction section which extracts a plurality of feature parts of a face in an image, a creating section which creates a portrait image of the face on a basis of the feature parts extracted by the extraction section, a specifying section which specifies, among the plurality of feature parts extracted by the extraction section, a feature part to be used as a feature in the portrait image by setting any one of a usage of the portrait image created by the creating section, a characteristic of the face and a relation between a person corresponding to the face and a user as a reference, and a creation control section which control creation of the portrait image by the creating section on a basis of the feature part specified by the specifying section.

According to an embodiment of the present invention, there is provided an image creating method using an image creating device which creates a portrait image which schematically expresses a face, and the method includes extracting a plurality of feature parts of a face in an image, creating a portrait image of the face on a basis of the feature parts extracted in the extracting, specifying, among the plurality of feature parts extracted in the extracting, a feature part to be used as a feature in the portrait image by setting any one of a usage of the portrait image created in the creating, a characteristic of the face and a relation between a person corresponding to the face and a user as a reference, and controlling creation of the portrait image in the creating on a basis of the feature part specified in the specifying.

According to an embodiment of the present invention there is provided a computer readable recording medium in which a program readable by a computer of an image creating device which creates a portrait image which schematically expresses a face is recorded, and the programs make the computer function as an extraction section which extracts a plurality of feature parts of a face in an image, a creating section which creates a portrait image of the face on a basis of the feature parts extracted by the extraction section, a specifying section which specifies, among the plurality of feature parts extracted by the extraction section, a feature part to be used as a feature in the portrait image by setting any one of a usage of the portrait image created by the creating section, a characteristic of the face and a relation between a person corresponding to the face and a user as a reference, and a creation control section which control creation of the portrait image by the creating section on a basis of the feature part specified by the specifying section.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram showing a schematic configuration of an image capturing device according to one embodiment to which the present invention is applied;

FIG. 2 is a flowchart showing an example of an operation relating to a portrait image creating process performed by the image capturing device of FIG. 1;

FIG. 3A schematically shows an example of an image according to the portrait image creating process of FIG. 2;

FIG. 3B schematically shows an example of an image according to the portrait image creating process of FIG. 2;

FIG. 3C schematically shows an example of an image according to the portrait image creating process of FIG. 2;

FIG. 4A schematically shows an example of an image according to the portrait image creating process of FIG. 2; and

FIG. 4B schematically shows an example of an image according to the portrait image creating process of FIG. 2.

### DESCRIPTION OF THE PREFERRED EMBODIMENTS

Hereinafter, a specific embodiment of the present invention will be described with reference to the drawings. However, the scope of the invention is not limited to what is exemplified in the drawings.

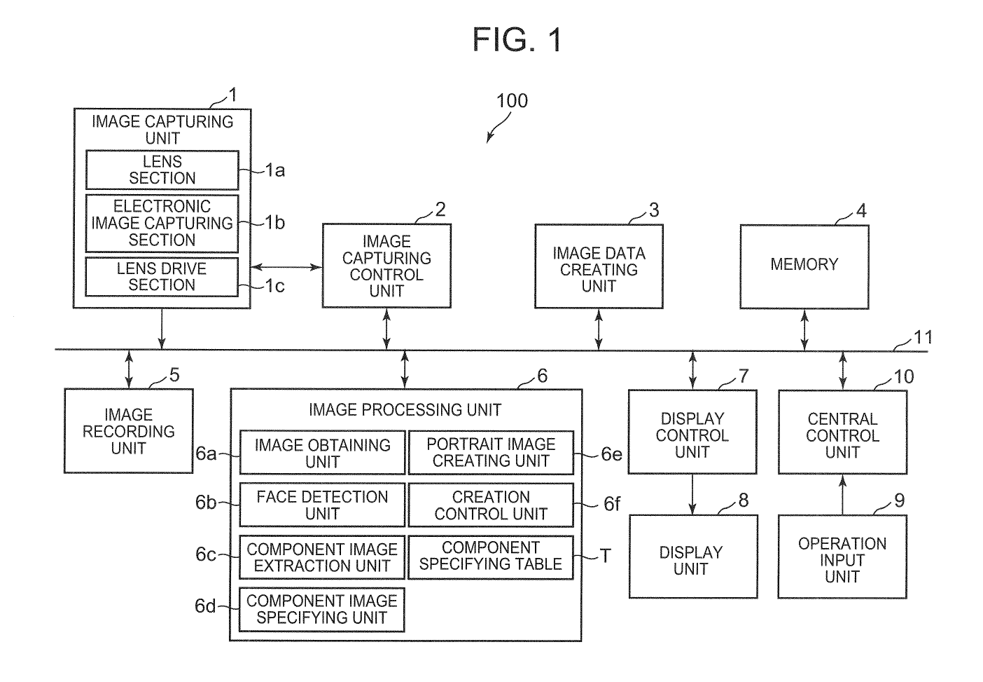

FIG. 1 is a block diagram showing a schematic configuration of an image capturing device 100 according to one embodiment to which the present invention is applied.

As shown in FIG. 1, the image capturing device 100 of the embodiment specifically includes an image capturing unit 1, an image capturing control unit 2, an image data creating unit 3, a memory 4, an image recording unit 5, an image processing unit 6, a display control unit 7, a display unit 8, an operation input unit 9 and a central control unit 10.

Moreover, the image capturing unit 1, the image capturing control unit 2, the image data creating unit 3, the memory 4, the image recording unit 5, the image processing unit 6, the display control unit 7 and the central control unit 10 are connected to one another through a bus line 11.

The image capturing unit 1, as an image capturing section, captures images of a predetermined subject and creates frame images.

Specifically, the image capturing unit 1 includes a lens section 1a, an electronic image capturing section 1b and a lens drive section 1c.

The lens section 1a is composed, for example, of a plurality of lenses such as a zoom lens and a focus lens.

The electronic image capturing section 1b is composed, for example, of an imaging sensor such as a CCD (charge coupled device) and a CMOS (complementary metal-oxide semiconductor). The electronic image capturing section 1b converts an optical image, which has passed through a variety of lenses of the lens section 1a, into a two-dimensional image signal.

The lens drive section 1c includes, for example, though not shown, a zoom drive unit that moves the zoom lens in an optical axis direction, a focusing drive unit that moves the focus lens in the optical axis direction, and the like.

Note that, in addition to the lens section 1a, the electronic image capturing section 1b and the lens drive section 1c, the image capturing unit 1 may include a diaphragm (not shown) that adjusts a quantity of light that passes through the lens section 1a.

The image capturing control unit 2 controls the image capturing of the subject performed by the image capturing unit 1. That is to say, though not shown, the image capturing control unit 2 includes a timing generator, a driver and the like. The image capturing control unit 2 scans and drives the electronic image capturing section 1b by the timing generator and the driver, and converts the optical image, which has passed through the lenses, into the two-dimensional image signal by the electronic image capturing section 1b in every predetermined cycle. Then, the image capturing control unit 2 reads out frame images one-by-one from an image capturing region of the electronic image capturing section 1b, and outputs the readout frame images to the image data creating unit 3.

Note that the image capturing control unit 2 may be configured to move the electronic image capturing section 1b in the optical axis direction instead of the focus lens of the lens section 1a, and may thereby adjust a focusing position of the lens section 1a.

Moreover, the image capturing control unit 2 may perform adjustment/control of conditions for performing image capturing of the subject, such as automatic focusing processing (AF), automatic exposure processing (AE) and automatic white balance (AWB).

The image data creating unit 3 appropriately performs gain adjustment of analog-value signals of the frame images, which are transferred thereto from the electronic image capturing section 1b, for each of color components of R, G and B, thereafter, performs sample-hold of the signals by a sample-and-hold circuit (not shown), and coverts the signals into digital data by an A/D converter (not shown). Then, the image data creating unit 3 performs color process treatment, which includes pixel interpolation processing and y-correction processing, on the digital data by a color processing circuit (not shown), and thereafter, creates digital-value brightness signals Y and color-difference signals Cb and Cr (YUV data).

The brightness signals Y and the color-difference signals Cb and Cr, which are output from the color processing circuit, are DMA-transferred through a DMA controller (not shown) to the memory 4 used as a buffer memory.

The memory 4 is composed, for example, of a DRAM (dynamic random access memory) or the like, and temporarily stores data and the like, which are to be processed by the image processing unit 6, the central control unit 10, and the like.

The image recording unit 5 is composed, for example, of a non-volatile memory (flash memory) and the like, and records image data to be recorded, the image data being encoded in accordance with a predetermined compression format (for example, a JPEG format and the like) by an encoding unit (not shown) of the image processing unit 6.

The image recording unit 5 is configured so that a recording medium (omitted in the drawing) is detachable, for example, and may be configured to control reading out of data from the installed recording medium and writing of data on the recording medium.

The image processing unit 6 includes an image obtaining unit 6a, a face detection unit 6b, a component image extraction unit 6c, a component image specifying unit 6d, a portrait image creating unit 6e and a creation control unit 6f.

Here, although each part of the image processing unit 6 is configured with a predetermined logic circuit, this is merely an example of a configuration and the present invention is not limited to such example.

The image obtaining unit 6a obtains an image which is subject to the portrait image creating process.

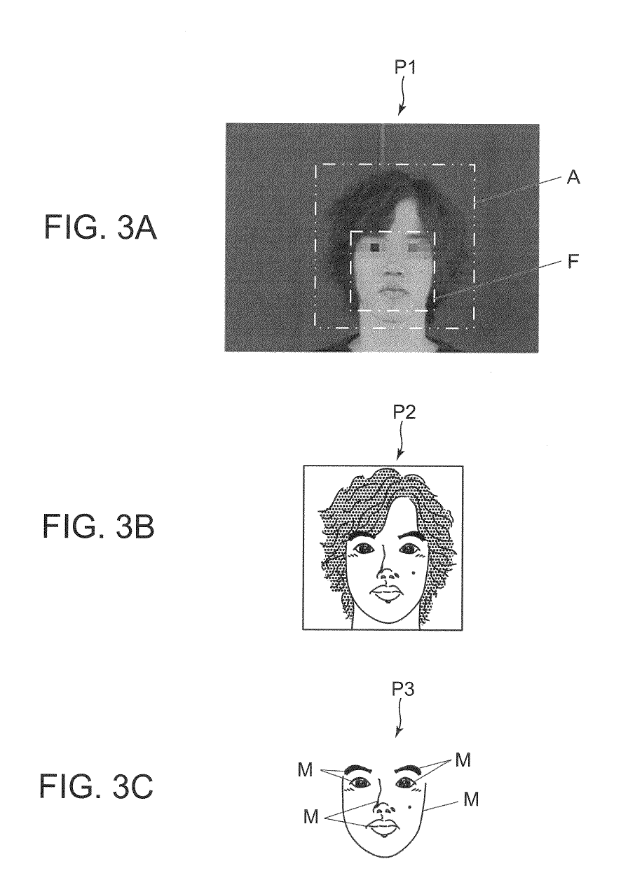

In other words, the image obtaining unit 6a, as an obtaining section, obtains image data of an original image (for example, photograph image or the like) P1. In particular, the image obtaining unit 6a obtains a copy of image data (RGB data or YUV data) of an original image P1, which is created by the image data creating unit 3 by capturing an image of a subject with the image capturing unit 1 and the image capturing control unit 2, from the memory 4 or the image obtaining unit 6a obtains a copy of image data of an original image P1 recorded in the image recording unit 5 (see FIG. 3A).

Processes to be performed by the after-mentioned image processing unit 6 may be performed on image data itself of the original image P1 or may be performed on reduced image data which is obtained by reducing image data of the original image P1, as needed, at a predetermined rate to a predetermined size (for example, VGA size or the like).

The face detection unit 6b detects a face region F (see FIG. 3A) in the original image P1 which is subject to processing.

In other words, the face detection unit 6b detects the face region F including a face in the original image P1 which is obtained by the image obtaining unit 6a. In particular, the face detection unit 6b obtains image data of the original image P3 which is obtained as an image subject to the portrait image creating process by the image obtaining unit 6a and detects the face region F by performing a predetermined face detection process on the image data. The face detection unit 6b cuts out a region A (see FIG. 3A) of a predetermined size that surrounds the face region F to form a face region image.

Here, since the face detection process is a well-known technique, detailed description will be omitted.

The component image extraction unit 6c extracts a plurality of face components in the original image P1.

That is, the component image extraction unit (extraction unit) 6c extracts main face components in the face in the original image P1 (see FIG. 3A) obtained by the image obtaining unit 6a to create a face component image P3. In particular, the component image extraction unit 6c performs a detail extraction process on the face region image A, which includes the face region F, of the original image P1 and creates a face detail image P2 (see FIG. 3B) in which face components such as eyes, nose, mouth, eye brows hair, face contour, etc. are expressed in lines. For example, the component image extraction unit 6c creates the face detail image P2 by a process utilizing AAM as the detail extraction process. Further, the component image extraction unit 6c performs the detail extraction process on the face region F detected in the image data of the original image P1 by the face detection unit 6b.

Here, AAM is a method for modelizing a visual matter and is a process for modelizing an image of an arbitrary face region F. For example, the component image extraction unit 6c registers positions of predetermined feature parts (for example, corners of eyes, tips of noses, face lines and the like) of a plurality of sample face images and statistical analysis results of pixel values (for example, brightness values) in a predetermined registration unit. Then, the component image extraction unit 6c sets a texture model which expresses “appearance” relating to a shape model of a face shape and an average shape by setting the positions of the feature parts and performs modeling of the image of the face region F using these models. In such way, the component image extraction unit 6c extracts the main components in the original image P1 and creates the face detail image P2 expressed in lines.

The component image extraction unit 6c creates the face component image P3 (see FIG. 3C) in which face components in the face contour of the face region F and face components adjacent to the face contour are expressed in lines by the detail extraction process.

In particular, the component image extraction unit 6c specifies the pixels in the face detail image P2 which are adjacent to the face contour and deletes the pixels outside of the face contour among the pixels which are continuous from the pixels adjacent to the face contour. That is, the component image extraction unit 6c deletes the parts in the face detail image P2 outside the face contour and also maintains the parts in the face detail image P2 inside the face contour and adjacent to the face contour to create the face component image P3 including part images M of main face components such as eyes, nose, mouth, eye brows, face contour, etc., for example.

In such way, the component image extraction unit 6c extracts a plurality of face components which are feature parts in the face, as an object, in the original image P1.

Here, the component image extraction unit 6c may extract and obtain information relating to a relative positional relation of the part images M of the face components in a XY plane space of information relating to coordinate positions of the part images M of the face components.

Here, although the process using AAM is described as an example of the detail extraction process, the process is not limited to such example and can be arbitrarily modified.

For example, as the detail extraction process, an edge extraction process or an anisotropic diffusion process may be performed to create the face component image P3 including the part images M of the face components. In particular, the component image extraction unit 6c may perform differential operation using a predetermined differential filter (for example, a high pass filter or the like) on the image data of the original image P1 and may perform the edge detection processing which detects the parts with radical changes in brightness values, colors and density as edges, for example. Further, the component image extraction unit 6c may perform the anisotropic diffusion process for smoothing on the image data of the original image P3 by varying the weight between the tangential direction of linear edges and the vertical direction of linear edges by using a predetermined anisotropic diffusion file, for example.

The component image specifying unit 6d specifies a predetermined number of face components to be used for creating a portrait image P4 among a plurality of face components.

That is, the component image specifying unit (specifying section) 6d specifies a predetermined number of face components to be used for creating the portrait image P4 among the plurality of face components extracted by the component image extraction unit 6c by setting at least one of the usage of the portrait image P4, the characteristics of the face as an abject and the relation between the object and a user as a reference.

In particular, the component image specifying unit 6d specifies, among the plurality of face components extracted by the component image extraction unit 6c, a predetermined number of face components whose features are to be relatively exaggerated in the portrait image P4 comparing to the other face components according to the usage of the portrait image P4.

For example, using the portrait as an item for a user to enjoy by himself/herself, using the portrait as a gift to a friend, using the portrait to be shown to the public, etc. are suggested as usages of the portrait image P4.

Further, for example, when any of the usages is specified on the basis of a predetermined operation performed by a user on the operation input unit 9, the component image specifying unit 6d refers to the component specifying table T (described later) to specify the face components which correspond with the specified usage of the portrait image P4 and then, specifies the specified face components as the face components whose features are to be relatively exaggerated comparing to other face components.

The component image specifying unit 6d further specifies, among the plurality of face components extracted by the component image extraction unit 6c, a predetermined number of face components whose features are to be relatively exaggerated in the portrait image P4 comparing to other face components according to the characteristics of the person corresponding to the face in the original image P1.

For example, age, gender, etc. of a person are suggested as the characteristics of a person corresponding to a face.

The component image specifying unit 6d performs a predetermined feature analysis process on the plurality of face components of the face in the original image P1, for example, to specify the characteristics such as age and gender of the person corresponding to the face. Thereafter, the component image specifying unit 6d refers to the component specifying table T (described later) to specify the face components corresponding with the specified characteristic and then, specifies the specified face components as the face components whose features are to be relatively exaggerated comparing to other face components. Here, age, gender or the like as the characteristic of the person corresponding to the face in the original image P1 may be specified by being input on the basis of a predetermined operation performed by a user on the operation input unit 9.

Further, the component image specifying unit 6d specifies, among the plurality of face components extracted by the component image extraction unit 6c, a predetermined number of face components which are to be relatively exaggerated comparing to other face components in the portrait image P4 according to the relation between the person corresponding to the face in the original image P1 and the user.

Here, user includes a person who creates the portrait image P4 and a person who looks at the created portrait image P4, for example. As for the relation between the person corresponding to the face in the original image P1 and the user, user himself/herself, friend, acquaintance, stranger, etc. are suggested.

For example, when any of the relations is specified on the basis of a predetermined operation performed by a user on the operation input unit 9, the component image specifying unit 6d refers to the component specifying table T (described later) to specify the face components which are corresponded with the specified relation and then, specifies the specified face components as the face components whose features are to be relatively exaggerated comparing to other face components.

The component specifying table T is a table used for specifying face components by the component image specifying unit 6d. In the component specifying table T, face components such as eyes, nose, mouth, face contour, etc. are associated with the usages of portrait image P4, the characteristics of the person corresponding to the face in the original image P1 and the relations between the person and the user.

The portrait image creating unit 6e creates a portrait image P4 which schematically expresses a face.

That is, the portrait image creating unit (creating section) 6e creates a portrait image P4 which schematically expresses a face as an object on the basis of the face components, which are feature parts, extracted by the component image extracting unit 6c. In particular, the portrait image creating unit 6e specifies positions inside the face contour of a predetermined hair style where part images M of face components such as eyes, nose, mouth, eye brows, etc. are to be superimposed. Further, the portrait image creating unit 6e superimposes the part images M of face components at the positions and creates image data of the portrait image P4 which expresses the original image P1 in a portrait manner. At this time, the portrait image creating unit 6e creates the portrait image P4 on the basis of the predetermined number of face components specified by the component image specifying unit 6d under the control of the creation control unit 6f (described later).

The portrait image creating unit 6e may create the portrait image P4 having a predetermined visual effect by an art conversion process.

As an art conversion process, “pastel effect” in which the image is processed so as to have visual effect as if drawn with pastel pencils, “silk screen effect” in which the image is processed so as to have visual effect as if it is printed on a silk screen and “oil paint effect” in which the image is processes so as to have visual effect as if it is oil painted are suggested, for example. However, the art conversion processing is not limited to the above examples and can be arbitrarily modified.

Techniques for processing an image to have various types of visual effects are realized by processes similar to the processing using software of known image processing, and are realized by changing color tone, chroma, brightness and the like in HSV color space and using various types of filters. Due to such techniques being known techniques, the detail description is omitted. Here, “XX effect” corresponds to a visual effect realized by performing an art conversion process which can be realized by using software related to the known image processing.

The portrait image creating unit 6e may create an image in which a predetermined parts (for example, face components such as eyes, mouth, eye bows, etc.) in the portrait image P4 are colored with predetermined colors.

The creation control unit 6f makes the portrait image creating unit 6e create a portrait image P4.

That is, the creation control unit (creation control section) 6f makes the portrait image creating unit 6e create a portrait image P4 on the basis of the predetermined number of face components specified by the component image specifying unit 6d. In particular, the creation control unit 6f makes the importance level of the predetermined number of face components which are specified be relatively high comparing to face components other than the specified predetermined number of face components and makes the portrait image creating unit 6e create a portrait image P4. For example, the creation control unit 6f makes the portrait image creating unit 6e create a portrait image P4 by relatively exaggerating the features of the specified predetermined number of face components comparing to other face components.

Here, exaggeration of face components means to emphasize (or tone down) the features of the face components comparing to other face components so as to make strong impression of the face components on a person who looks at the portrait image. As an example of exaggeration of face components, for example, deforming of shape features of the face components themselves so as to be relatively emphasized such as relatively enlarging (or reducing) the size of the face components such as eyes, nose, mouth, etc., changing color features of the face components so as to be relatively emphasized, changing the shape and color of patter features of the face components so as to be relatively emphasized, and the like are suggested. Exaggeration level of the face components may be changed continuously or may be changed in a stepwise manner.

According to the result of a predetermined feature analysis process performed on the plurality of face components by the component image specifying unit 6d, the creation control unit 6f may change the relative exaggeration level of the features of the predetermined number of face components comparing to other face components and make the portrait image creating unit 6e create a portrait image P4.

For example, in a case where the component image specifying unit 6d specifies that the face in the original image P1 is at a predetermined age or younger (for example, 5 years old) (a young child), if there is great similarity between the features of the number of face components of the face and the features which are the reference of childlikeness, the creation control unit 6f increases the exaggeration level of the features of the predetermined number of face components relatively comparing to other face components and makes the portrait image creating unit 6e create a portrait image P4. On the other hand, if there is little similarity between the features of the plurality of face component in the face and the features which are the reference for childlikeness, the creating control unit 6f makes the exaggeration level of the features of the predetermined number of face components be relatively low comparing to other face components and makes the portrait image creating unit 6e create a portrait image P4.

Further, for example, in a case where the usage of the portrait image P4 is as a gift or to be shown to public and when the component image specifying unit 6d specifies that the face in the original image P1 is in a predetermined age range (for example, in teens, in twenties, etc.) (in the range between adolescence and young adulthood), if there is a great similarity between the features of the plurality of face components in the face and the features which are the reference of a predetermined gender (for example, round contour in case of a woman and square contour in case of a man), the creation control unit 6f increases the exaggeration level of the features of the predetermined number of face components relatively comparing to other face components and makes the portrait image creating unit 6e create a portrait image P4. On the other hand, if there is little similarity between the features of the plurality of face components of the face and the features which are the reference of a predetermined gender (for example, angular face contour in case of a woman and round contour in case of a man), the creation control unit 6f decreases the exaggeration level of the features of the predetermined number of face components relatively comparing to other face components and makes the portrait image creating unit 6e create a portrait image P4.

Further, for example, in a case where the usage of the portrait image P4 is as a gift or to be shown to public and when the component image specifying unit 6d specifies that the face in the original image P1 is in a predetermined age range (for example, in thirties to fifties, etc.) (in the range between mid-age and senior age), if there is great similarity between the features of the plurality of face components of the face and the features which are the reference of age (for example, smile lines and wrinkles in forehead are deeply creased), the creation control unit 6f decreases the exaggeration level of the features of the predetermined number of face components relatively comparing to other face components (that is, to not clearly show the age) and makes the portrait image creating unit 6e create a portrait image P4. For example, in a case where the usage of the portrait image is as a gift to grandparents from a grandchild, the creation control unit 6f may increase the exaggeration level of the features of the predetermined number of face components relatively comparing to other face components (that is, to clearly show the age) and make the portrait image creating unit 6e create a portrait image P4.

Further, for example, when the component image specifying unit 6d specifies that the face in the original image P1 is in a predetermined age range (for example, in sixties) (in old age) and if there is a great similarity between the features of the plurality of face components in the face and the feature which are the reference of age (for example, smile lines and wrinkles in forehead are deeply creased), the creation control unit 6f may increase the exaggeration level of the features of the predetermined number of face components relatively comparing to other face components (that is, to clearly show the age) and make the portrait image creating unit 6e create a portrait image P4. On the other hand, if there is little similarity between the features of the plurality of face components of the face and the features which are the reference of age (for example, smile lines and wrinkles in forehead are not deeply creased), the creation control unit 6f decreases the exaggeration level of the features of the predetermined number of face components relatively comparing to other face components (that is, to not clearly show the age) and makes the portrait image creating unit 6e create a portrait image P4.

If an instruction for specifying face components is input on the basis of a predetermined operation performed by a user on the operation input unit 9 after the portrait image P4 is created, the creation control unit 6f makes the portrait image creating unit 6e create the portrait image P4 again on the basis of the face components corresponding to the specifying instruction.

That is, when an instruction for specifying, among the first list (described later) relating to the relatively exaggerated face components displayed in the display unit 8 and the second list (described later) relating to the face components which are not exaggerated, a face component to be used for generating a portrait image P4 again is input on the basis of a predetermined operation performed by a user on the operation input unit (input unit) 9 after the portrait image P4 is created, the creation control unit 6f increases the importance level of the face component corresponding to the specifying instruction relatively comparing to other face components and makes the portrait image P4 create the portrait image P4.

The display control unit 7 controls to read out the image data for display temporarily stored in the memory 4 and to display the read data in the display unit 8.

In particular, the display control unit 7 includes a VRAM (Video Random Access Memory), a VRAM controller, a digital video encoder and the like. The digital video encoder reads out the brightness signals Y and the color difference signals Cb and Cr which are read out from the memory 4 and stored in the VRAM (not shown) under the control of the central control unit 10 regularly from the VRAM via the VRAM controller, and then, generates video signal based on the data and outputs the video signal to the display unit 8.

The display unit 8 is a liquid crystal display panel, for example, and displays an image captured by the image capturing unit 1 in the display screen on the basis of the video signal from the display control unit 7. In particular, the display unit 8 displays a live view image while sequentially updating with a plurality of frame images created by capturing a subject image by the image capturing unit 1 and the image capturing control unit 2 in a still image capturing mode and a video capturing mode. Further, the display unit 8 displays images recorded as still images (rec view image) and also displays the image being recorded as video.

After the portrait image P4 is created, the display unit (information section) 8 informs the face components used in generation of the portrait image P4.

In particular, the display control unit 7 generates the first screen data according to the list display of the predetermined number of face components which are relatively exaggerated comparing to other face components among the face components used in the generation of the portrait image P4 and also generates the second screen data according to the list display of the face components which are not relatively exaggerated comparing to other face components among the face components used in the generation of the portrait image P4. Then, the display control unit 7 outputs the generated first screen data and second screen data to the display unit 8 to display the first list of the face components which are relatively exaggerated and the second list of face component which are not exaggerated in the display unit 8.

Here, for example, in a case where the usage of the portrait image P4 is as a gift or to be shown to public, the display unit 8 may display a confirmation screen such as showing “** will be exaggerated. OK to be shown to public?”.

Here, displaying of face components as a list in the display unit 8 is exemplified as a mode for announcing face components as feature parts of an object. However, this is an example and is not limitative in any way and the notifying mode can be changed arbitrarily. That is, the information mode of face components may be of any mode as long as the face components can be recognized by any of the five senses of a person, especially by visual, hearing, touching and the like. For example, a specific face component may be notified by sound (voice or the like) or vibration.

The operation input unit 9 is for performing a predetermined operation of the image capturing device 100. In particular, the operation input unit 9 includes operating units such as a shutter button relating to capturing instructions of a subject, a selection deciding button relating to selection instructions of image capturing modes and functions, a zoom button relating to adjustment instructions of zooming and the like (all of them are omitted in the drawing), and the operation input unit 9 outputs predetermined operation signals according to the operations of the buttons which are the operating units to the central control unit 10.

The central control unit 10 controls the parts in the image capturing device 100. In particular, the central control unit 10 includes a CPU (Central Processing Unit) (omitted in the drawing) and the like and performs various controlling operations according to various types of processing programs (omitted in the drawing) for the image capturing device 100.

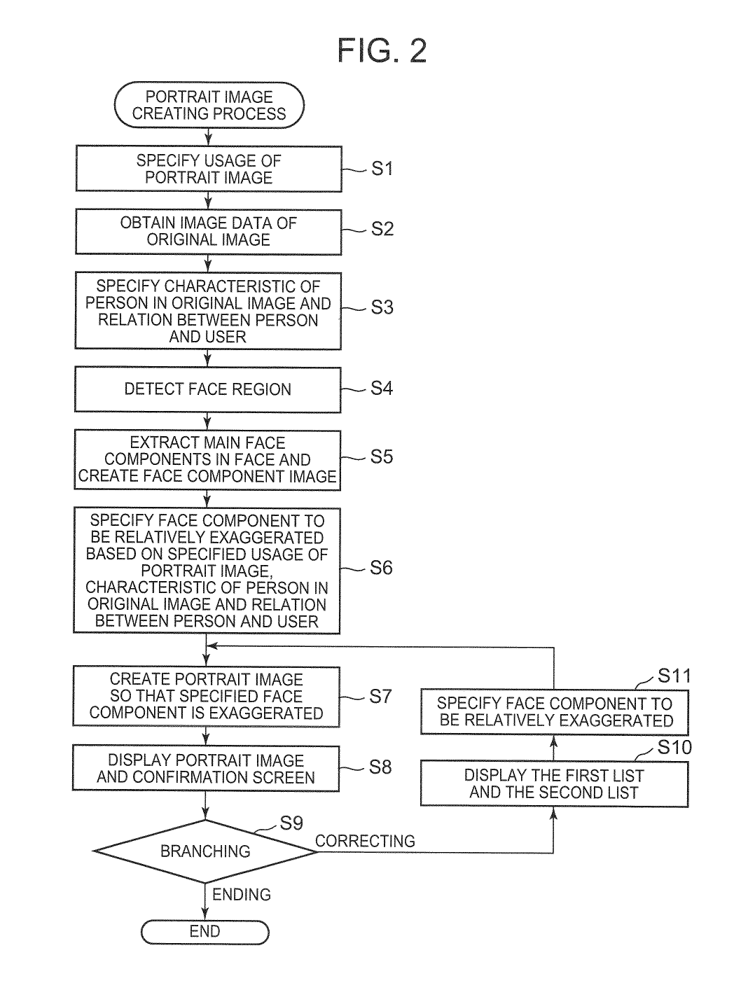

Next, a portrait image creating process performed in the image capturing device 100 will be described with reference to FIGS. 2 to 4.

FIG. 2 is a flowchart showing an example of an operation relating to a portrait image creating process.

The portrait image creating process is a process which is executed by the parts in the image capturing device 100, especially by the image processing unit 6, under the control of the central control unit 10 when the portrait image creation mode is selected and instructed among a plurality of operation modes displayed in the menu screen on the basis of a predetermined operation performed by a user on the selection OK button in the operation input unit 9.

Further, it is assumed that the image data of the original image P1 which is subject to the portrait image creating process is stored in the image recording unit 5 in advance.

As shown in FIG. 2, first, the display control unit 7 makes the display unit 8 display a selection screen of a plurality of usages of the portrait image P4, and the component image specifying unit 6d specifies any of the usages selected among the usages on the basis of a predetermined operation performed by a user on the operation input unit 9 (step S1).

Next, the image recording unit 5 reads out, among the recorded image data, the image data of the original image P1 (see FIG. 3A) specified on the basis of a predetermined operation performed by a user on the operation input unit 9, and the image obtaining unit 6a of the image processing unit 6 obtains the read image data as the processing target of the portrait image creating process (step S2).

Next, the component image specifying unit 6d specifies the characteristics of the person in the obtained original image p1 and the relation of the person to the user (step S3). In particular, for example, the component image specifying unit 6d determines whether additional information such as the characteristics of the person in the original image P1 and the relation of the person to the user is attached to the image data of the obtained original image P1. If it is determined that the additional information is attached, the component image specifying unit 6d obtains the characteristics of the person in the original image P1 and the relation of the person to the user which are attached. On the other hand, if it is determined that the additional information is not attached, the display control unit 7 may display the input screen to input the characteristics of the person in the original image P1 and the relation of the person to the user in the display unit 8, and the component image specifying unit 6d may specify the characteristics of the person in the original image P1 and the relation of the person to the user which are input based on predetermined operations performed by the user on the operation input unit 9 and add the information relating to the characteristics of the person in the original image P1 and the relation of the person to the user to the image data of the original image P1 as additional information.

Next, the face detection unit 6b performs a predetermined face detection process on the image data of the original image P1 obtained by the image obtaining unit 6a to detect a face region F (step S4).

Next, the component image extraction unit 6c extracts main face components of the face in the face region F and generates a face component image P3 (step S5). In particular, the component image extraction unit 6c performs the detail extraction process (for example, a process utilizing AAM) on the face region image A including the detected face region F to generate a face detail image P2 (see FIG. 3B) in which face components such as eyes, nose, mouth, eyebrows, hair, face contour, etc. are expressed in lines. Then, the component image extraction unit 6c generates a face component image P3 including the face components inside the face contour of the face region F and the face components adjacent to the face contour, that is, including parts images M of main face components such as eyes, nose, mouth, eye brows, face contour, etc. by the detail extraction process (see FIG. 3C).

Next, the component image specifying unit 6d specifies, among the plurality of face components extracted by the component image extraction unit 6c, a predetermined number of face components whose features are to be relatively exaggerated comparing to other face components in the portrait image P4 based on the specified usage of the portrait image P4, the characteristics of the person in the original image P1 and the relation of the person to the user (step S6). In particular, for example, the component image specifying unit 6d refers to the component specifying table T to specify the face components which correspond with the specified usage of the portrait image P4, the face components which correspond with the specified characteristics of the person and the face components which correspond with the specified relation of the person to the user, and these specified face components are specified as the face components whose features are to be relatively exaggerated comparing to other face components.

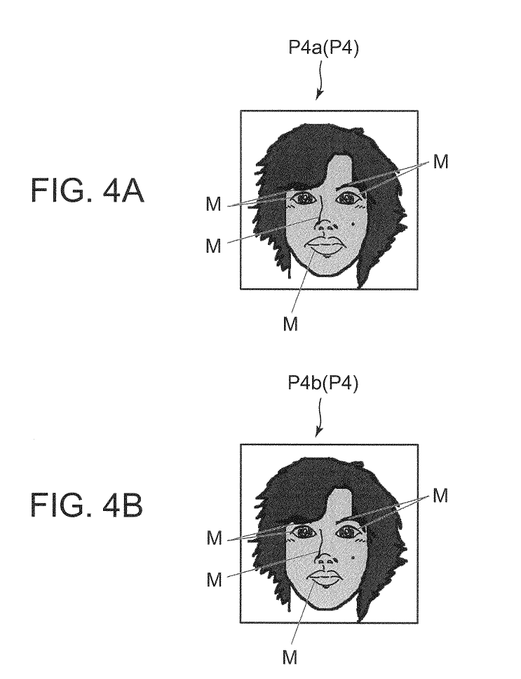

Next, the creation control unit 6f makes the portrait image creating unit 6e create the portrait image P4a (see FIG. 4A) in which features of the face components specified by the component image specifying unit 6d are relatively exaggerated comparing to other face components (step S7). In particular, the portrait image creating unit 6e creates image data of part images M which are deformed and whose colors are changed, under the control of the creation control unit 6f, so as to relatively emphasize the shape features of the face components themselves which are specified by the component image specifying unit 6d, relatively emphasize the color features of the face components and relatively emphasize the pattern features of the face components. Then, the portrait image creating unit 6e specifies the positions inside the face contour of a predetermined hair style image where the part images M of the relatively exaggerated face components and the face components which are not exaggerated are to be superimposed, and the portrait image creating unit 6e generates image data of the portrait image P4a in which the part images M of the face components are superimposed on the specified position.

Thereafter, the display control unit 7 obtains the image data of the portrait image P4a generated by the portrait image creating unit 6e and displays the portrait image P4a in the display unit 8. Further, the display control unit 7 also displays the confirmation screen (not shown) for inputting an ending instruction to end creating of the portrait image P4 and a correction instruction of the portrait image P4 in the display unit 8 (step S8).

In a case where the usage of the portrait image P4 is to be shown to public, the decision whether the portrait image P4 can be shown to public may be received through the above mentioned confirmation screen.

If the user decides that he/she is not satisfied with the finalized portrait image P4a and if a correction instruction of the portrait image P4a is input (step S9; correcting), the display control unit 7 displays the first list relating to the face components which are relatively exaggerated and the second list relating to the face components which are not exaggerated in the display unit 8 (step S10). In particular, the display control unit 7 generates the first screen data according to a list display of the face components which are relatively exaggerated comparing to other face components and the second screen data according to a list display of the face components which are not relatively exaggerated comparing to other face components. Then, the display control unit 7 outputs the generated first screen data and second screen data to the display unit 8 and displays the first list and the second list in the display unit 8.

Thereafter, when the face components to be used for creating the portrait image P4a again are specified among the plurality of face components in the first list and the second list on the basis of a predetermined operation performed by a user on the operation input unit 9 (step S11), the creation control unit 6f moves on to the process of step S7 and makes the portrait image creating unit 6e create a portrait image P4b (see FIG. 4B) in which the face components corresponding to the specifying instruction are exaggerated comparing to other face components (step S7).

FIG. 4A shows the portrait image P4a in which “eyes”, “eye brows” and “mouth” are relatively exaggerated comparing to other face components and FIG. 4B shows the portrait image P4b in which “eyes” and “eye brows” are relatively exaggerated comparing to other face components. However, they are examples and are not imitative in any way, the portrait images may be changed arbitrarily.

Thereafter, in step S8, the display control unit 7 displays the portrait image P4b which is created by the portrait image creating unit 6e and the confirmation screen for inputting the ending instruction to end creating of the portrait image P4 and a correction instruction of the portrait image P4 in the display unit 8 (step S8).

On the other hand, if the user decides that he/she is satisfied with the finalized portrait image P4a (or the portrait image P4b) and if the ending instruction to end creating of the portrait image P4 is input (step S9; end), the portrait image creating process ends.

In the above described portrait image creating process, the portrait image P4 may be processed into an image having various visual effects by the art conversion process.

As described above, according to the image capturing device 100 of the embodiment, among the usage of the portrait image P4, the characteristics of the person corresponding to the face in the original image P1 and the relation of the person to the user, at least one is set as the reference to specify a predetermined number of face components to be used for creating the portrait image P4 among the plurality of face components extracted in the original image P1, and the portrait image P4 is created on the basis of the specified predetermined number of face components. Therefore, a characteristic portrait image P4 can be created by taking the usage of the portrait image P4, the characteristics of the person corresponding to the face in the original image P1, the relation of the person to the user, etc. in to consideration, and the creation of the portrait image P4 can be performed appropriately in a view point of user's satisfaction.

In particular, since the portrait image P4 is created by increasing the importance level of the specified predetermined number of face components relatively to other face components, that is, by relatively exaggerating the predetermined number of face components comparing to other face components, a characteristic portrait image P4 can be created by using the predetermined number of face components which are specified according to the usage of the portrait image P4, the characteristics of the person corresponding to the face in the original image P1, the relation of the person to the user, etc. In such way, for example, creation of a portrait image P4 in which the face components which the subject who is the model of the portrait image P4 is not fond of are exaggerated or a portrait image P4 in which the features of the subject of the portrait image P4 are not sufficiently expressed can be prevented. Further, unpleasant feeling that may occur in the subject who is the model of the portrait image P4 and in a person who looks as the portrait image P4 can be reduced, that is, satisfaction level of the subject who is the model of the portrait image P4 and the person who looks as the portrait image P4 can be improved.

Further, since a predetermined number of face components, which are to be relatively exaggerated in the portrait image P4 comparing to other face components, are specified among the plurality of face components according to the usage of the portrait image P4, the characteristics of the person corresponding to the face in the original image P1, the relation of the person to the user, etc., specifying of the face components to be used for creation of the portrait image P4 can be carried out appropriately.

Further, since, after the portrait image P4 is created, the face components which are used for creating the portrait image P4 are notified and the portrait image P4 is created again by the portrait image creating unit 6e on the bases of the face components corresponding to the specifying instruction input based on a predetermined operation performed by a user on the operation input unit 9, the portrait image P4 can be created again by re-specifying the face components at the discretion of the person who creates the portrait image P4 even in a case where a portrait image P4 in which the face components which the subject who is the model of the portrait image P4 is not fond of are exaggerated or a portrait image P4 in which the features of the subject of the portrait image P4 are not sufficiently expressed is created.

The present invention is not limited to the above described embodiment, and various modifications and changes in design can be carried out within the scope of the present invention.

For example, in the above described embodiment, the component image specifying unit 6d specifies the face components to be used to create the portrait image P4 by using the component specifying table T. However, this is an example of a method of specifying face components by the component image specifying unit 6d and is not limitative in any way, and the specifying method can be changed arbitrarily.

Further, in the above embodiment, examples of the portrait image P4 is shown. However, the image may be any image such as a so-called avatar image and the like which is an image schematically expresses an object in an original image P1, for example.

The image which is the source of the portrait image P4 does not need to be an image of a face facing front. For example, in a case where the original image P1 includes an image of a face tilted facing a diagonal direction centering a predetermined axis, an image where the face in the original image P1 is deformed so as to face font may be created to be used.

Further, the configuration of the image capturing device 100 described in the above embodiment is an example and is not limitative in any way. Although, the image capturing device 100 is exemplified as an image creating apparatus, the image creating apparatus is not limited to this and may be in any configuration as long as the configuration can realize execution of the image creating process according to the present invention.

In addition, in the above embodiment, functions of an extraction section, a creating section, a specifying section and a creation control section are realized respectively by the component image extraction unit 6c, the portrait image creating unit 6e, the component image specifying unit 6d and the creation control unit 6f under the control of the CPU of the central control unit 10. However, this configuration is not limitative in any way, and the configuration may be such that the above functions are realizes by a predetermined program and the like being executed by the CPU of the central control unit 10.

That is, a program including an extraction process routine, a creating process routine, a specifying process routine and a creation control process routine is to be stored in the program memory (not shown) for storing programs in advance. The extraction process routine may make the CPU of the central control unit 10 function as a unit for extracting a plurality of face components from a face in an image. The creating process routine may make the CPU of the central control unit 10 function as a unit for creating a portrait image of the face on the basis of the extracted detail parts. The specifying process routine may make the CPU of the central control unit 10 function as a unit for specifying the feature parts to be used as the features in the portrait image among the plurality of extracted feature parts by using at least one of the usage of the created portrait image, the characteristics of the face and the relation of the person of the face to the user as the reference. The creation control process routine may make the CPU of the central control unit 10 function as a unit for controlling the creation of the portrait image on the basis of the specified feature parts.

Similarly, with respect to the notifying unit and the input unit, their configurations may also be such that their functions are realized by a predetermined program and the like being executed by the CPU of the central control unit 10.

Moreover, as for the computer readable medium in which programs for executing the above processes are stored, in addition to a ROM, hard disk or the like, a non-volatile memory such as flash memory, portable recording medium such as CD-ROM (Compact Disc Read Only Memory), read only DVD (Digital Versatile Disc) and writable type DVD may be applied. Moreover, as for a medium which provides data of programs through a predetermined communication circuit, a carrier wave is applied.

In the above, various embodiments of the present invention are described. However, the scope of the present invention is not limited to the above described embodiments and the present invention includes the scope of the claims and the equivalents thereof.

The entire disclosure of Japanese Patent Application No. 2013-029064 filed on Feb. 18, 2013 including description, claims, drawings, and abstract are incorporated herein by reference in its entirety.

What is claimed is:

1. An image creating device, comprising:
an extraction section which extracts a plurality of feature parts of a face in an image;
a creating section which creates a portrait image of the face on a basis of the feature parts extracted by the extraction section;
a specifying section which specifies, among the plurality of feature parts extracted by the extraction section, a feature part to be used as a feature in the portrait image by setting any one of a usage of the portrait image created by the creating section, a characteristic of the face and a relation between a person corresponding to the face and a user as a reference; and
a creation control section which control creation of the portrait image by the creating section on a basis of the feature part specified by the specifying section.

2. The image creating device as claimed in claim 1, wherein the creation control section increases an importance level of the feature part specified by the specifying section relatively comparing to other feature parts and makes the creating section create the portrait image.

3. The image creating device as claimed in claim 1, wherein the creation control section makes the creation section create the portrait image by changing a relative exaggeration level of the feature part specified by the specifying section comparing to other feature parts.

4. The image creating device as claimed in claim 3, wherein the specifying section specifies, among the plurality of feature parts, the feature part whose exaggeration level is to be changed with respect to the other feature parts in the portrait image according to the usage of the portrait image.

5. The image creating device as claimed in claim 3, wherein the specifying section specifies, among the plurality of feature parts, the feature part whose exaggeration level is to be changed with respect to the other feature parts in the portrait image according to the characteristic of the face.

6. The image creating device as claimed in claim 3, wherein the specifying section specifies, among the plurality of feature parts, the feature part whose exaggeration level is to be changed with respect to the other feature parts in the portrait image according to the relation between the person corresponding to the face and the user.

7. The image creating device as claimed in claim 1, further comprising:
an information section which informs the feature parts used to create the portrait image after the portrait image is created; and
an input section which inputs a specifying instruction of feature parts used to create the portrait image on a basis of a predetermined operation performed by a user on an operation section,
wherein
the creation control section makes the creating section create the portrait image again on a basis of the feature parts corresponding to the specifying instruction input by the input section.

8. The image creating device as claimed in claim 1, wherein the creation control section relatively enlarges or reduces the feature part specified by the specifying section.

9. The image creating device as claimed in claim 1, wherein the creation control section changes a shape feature of the feature part itself specified by the specifying section so that the shape feature is relatively emphasized.

10. The image creating device as claimed in claim 1, wherein the creation control section changes a color of a color feature of the feature part specified by the specifying section so that the color feature is relatively emphasized.

11. The image creating device as claimed in claim 1, wherein the creation control section changes at least one of a shape and a color of a pattern feature of the feature part specified by the specifying section so that the pattern feature is relatively emphasized.

12. An image creating method using an image creating device which creates a portrait image which schematically expresses a face, the method comprising:
extracting a plurality of feature parts of a face in an image;
creating a portrait image of the face on a basis of the feature parts extracted in the extracting;
specifying, among the plurality of feature parts extracted in the extracting, a feature part to be used as a feature in the portrait image by setting any one of a usage of the portrait image created in the creating, a characteristic of the face and a relation between a person corresponding to the face and a user as a reference; and
controlling creation of the portrait image in the creating on a basis of the feature part specified in the specifying.

13. A computer readable recording medium in which a program readable by a computer of an image creating device which creates a portrait image which schematically expresses a face is recorded, the programs make the computer function as:
an extraction section which extracts a plurality of feature parts of a face in an image;
a creating section which creates a portrait image of the face on a basis of the feature parts extracted by the extraction section;
a specifying section which specifies, among the plurality of feature parts extracted by the extraction section, a feature part to be used as a feature in the portrait image by setting any one of a usage of the portrait image created by the creating section, a characteristic of the face and a relation between a person corresponding to the face and a user as a reference; and
a creation control section which control creation of the portrait image by the creating section on a basis of the feature part specified by the specifying section.
